(19) United States
(12) Patent Application Publication
(10) Pub. No.: US 2009/0233635 A1
(43) Pub. Date: Sep. 17, 2009

(54) Discovering neighbors in wireless personal area networks

(76) Inventors: Guoqing C. Li, Portland, OR (US); Carlos Cordeiro, Portland, OR (US); Alex Kesselman, San Jose, CA (US); Praveen Gopalakrishnan, Hillsboro, OR (US)

Correspondence Address: TROP, PRUNER & HU, P.C., 1616 S. VOSS RD., SUITE 750, HOUSTON, TX, 77057-2631, US

(21) Appl. No.: 12/150,622

(22) Filed: Apr. 30, 2008

Related U.S. Application Data
(60) Provisional application No. 61/035,480, filed on Mar. 11, 2008.

(51) Int. Cl. H04B 7/26; H04B 17/00; H04B 1/02

(52) U.S. Cl. 455/509; 455/129; 455/67.13

(57) ABSTRACT

A neighbor discovery protocol enables a network coordinator to provide time periods during which different classes of devices produce training sequences. The coordinator can transmit information about these time periods in a plurality of different directions so that in-range devices with directional antenna systems receive the communication. The coordinator can also compile interference reports during the neighbor discovery period and thereafter. These reports may be useful in determining whether or not spatial reuse is appropriate between two particular nodes in a given link, in a particular direction.

### RELATED APPLICATION

This application claims the benefit under 35 U.S.C. § 119(e) to U.S. Provisional Patent Application No. 61/035,480, filed Mar. 11, 2008 and is hereby incorporated by reference in its entirety.

### BACKGROUND

This relates generally to wireless personal area networks and other wireless systems.

In wireless personal area networks, a number of wireless devices may move into and out of range of other wireless devices. When those devices move in-range, they establish a network, such as a piconet, which enables the devices to communicate with one another.

A communication link may operate at 60 gigaHertz band. But such a network may be less robust due to inherent characteristics of high oxygen absorption and attenuation through obstructions. In order to satisfy the link budget requirements, directional antennas, such as fixed, adaptive beamforming, or sectorized antennas, may be used to create communication links.

One of the challenges associated with a directional antenna is neighbor discovery. Neighbor discovery involves two devices pointing at each other at the right time, with one transmitting and one receiving. If the two devices rotate their beams through 360 degrees, the two devices may never discover one another if their beams never cross or meet.

### BRIEF DESCRIPTION OF THE DRAWINGS

FIG. 1 is a schematic depiction of a network in accordance with one embodiment;

FIG. 2 includes flow charts for devices on the network according to one embodiment;

FIG. 3 is a packet structure for one embodiment;

FIG. 4 is a flow chart for establishing a coordinator based node compatibility table according to one embodiment; and

FIG. 5 is a flow chart for still another embodiment.

### DETAILED DESCRIPTION

A neighbor discovery protocol may be utilized in any centralized network, such as a high data rate wireless personal area network (WPAN) (IEEE 802.15.3 “Wireless Medium Access Control (MAC) and Physical Layer (PHY) specification for High Rate Wireless Personal Area Networks (WPANs)” IEEE, Inc., New York, N.Y.), or through a proxy node in a distributed network, such as ultra-wideband (IEEE 802.15.3a). A proxy node can reserve bandwidth after the beacon and may allocate time slots for training sequence transmissions by neighbors.

In a wireless personal area network, such as a 60 gigaHertz network, a superframe structure may be utilized to transmit information between nodes or devices making up the network. Initially, there may be a beacon period (BP) in which a coordinator transmits information to existing members of the network and to any other devices that may be listening with the intent to join a network. The coordinator may be any device on a network that has assumed the role of coordinating communications between the various devices in the network.

In one embodiment, the coordinator transmits the order and identities of the nodes that will transmit training sequences in each of at least two training periods. One training period is new member discovery (NDP) and the other is for old or existing network member discovery by the new member devices, as well as discovery of new positions for existing members that have moved. To ensure that this communication is received by relocated old members and by new members, the communication may be sequentially directionally broadcast, in what may be called “pseudo-omni” mode, in each of a finite number (e.g. 5 to 8) of sectors or directions so that any in-range devices will receive the communication.

After a beacon period, a time period called the coordinator discovery period (CDP) is dedicated for the coordinator to send discovery packets for new devices. This communication may also be made in pseudo-omni mode. This enables new devices entering the network to perform wireless personal area network coordinator discovery and initial antenna training, as well as for old devices to fine tune their antennas. As used herein, “antenna training” is merely locating neighbors and tuning a receiver to receive communications from those neighbors and tuning a transmitter to transmit to those neighbors, given their current location. This, of course, assumes that each of the devices in the network uses a directional antenna.

The new member discovery period (NDP) occurs after the CDP in some embodiments. NDP may be dedicated for new devices to send training sequences so that their neighbors can discover the new device and obtain initial direction information for the new device. The old member discovery period (ODP) may occur after the NDP in some embodiments. The ODP may be used for existing devices to send training sequences so that the new devices or any existing neighbors can discover or rediscover them and obtain the updated direction information.

The training sequence or discovery packets may be sent through a sectorized or beamforming antenna to multiple directions in a certain fashion. For example, the packets may be sent in a robin fashion. Alternatively, the training sequence or discovery packets may be sent through omnidirectional antennas if the network device has such an antenna. Each training period may not be present in every superframe and the order of number of periods may change.

The coordinator can also schedule a period, called dynamic discovery, anywhere in the superframe if changes in the network topology necessitate an immediate update. The dynamic discovery period may be dedicated for devices that change their locations to send training sequences so that the rest of the devices in the network can update their direction information. The dynamic discovery period may be applied to beam tracking and even device mobility scenarios.

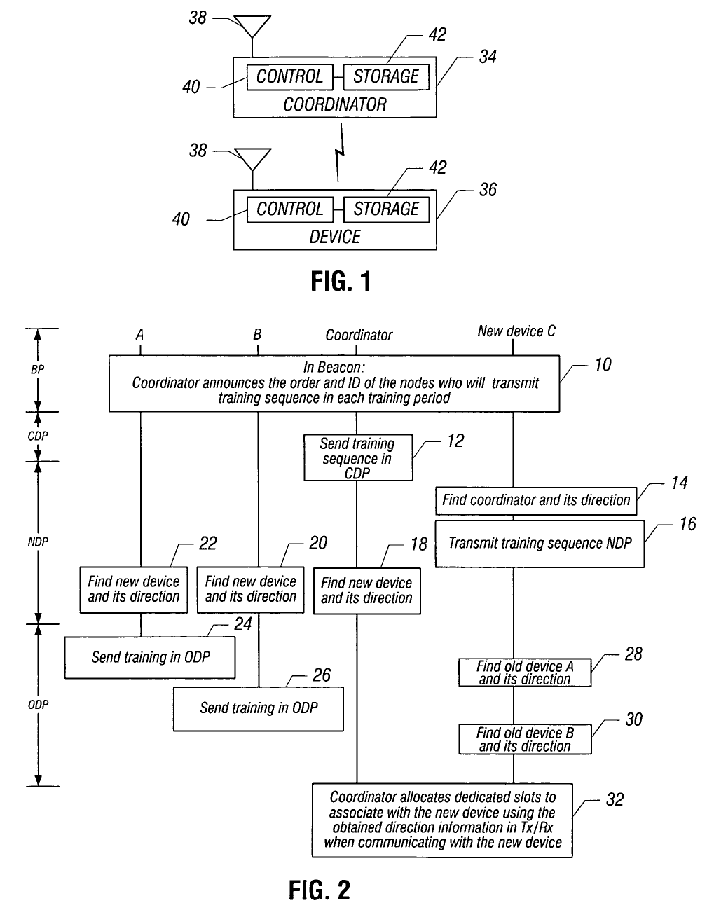

Referring to FIG. 1, a network may include a coordinator 34 that may be no different than one or more other devices 36 that make up the rest of the network. Each of the coordinator 34 and the devices 36 in the network may be a wireless device including a directional antenna 38 and a control 40, such as a processor coupled to a storage 42. The storage 42 may store data and/or code.

The coordinator 34 broadcasts, in a beacon or bandwidth reservation frame (BP), a schedule specifying the order and identifiers of all nodes or devices, already part of the network, that will transmit training sequences, as indicated in block 10 and FIG. 2. The coordinator also sets the times for NDP and ODP.

Block 10 is actually initiated by the coordinator, although an association with each of three existing network devices A, B, and new device C is also indicated. Of course, any number of devices may be involved in the network and three devices are provided for illustration purposes only.

As a result, all of the devices in the network, but one, remain silent during the training time slots that are not dedicated to them so that training or retraining antennas may occur for the transmitting neighbor.

New devices, such as the device C in FIG. 2, synchronize with the superframe before transmissions can occur. Hence, new devices scan for beacon transmissions from other devices. If no beacon transmissions are received, the new devices start their own superframe and become coordinators.

On the other hand, if a beacon is received, the new device has two options. It can attempt to associate with the network whose beacon was received through a contention period. In such case, the coordinator of the network allocates a dedicated training period during the NDP for this new device to transmit. The training sequence is then sent collision-free.

Alternatively, a new device that has received a beacon from a network may skip association and transmit its training packet directly during the NDP to allow neighboring devices including the coordinator to discover the new device. The association process can be done after that, as indicated in FIG. 2.

In FIG. 2, there may be multiple new devices trying to send training sequences for discovery and, if so, the coordinator divides the NDP into sub-periods with each new device randomly choosing one period to send its training sequence in order to avoid collisions, in one embodiment.

Another collision reduction method is to define multiple orthogonal training sequences in which each device may have the capability of multiple matched filters to correlate each training sequence. Then a device may randomly choose one of the training sequences in the NDP period.

Because the time spent on the training sequence can be lengthy, all discovery periods need not be present in each superframe. In addition, not all existing devices need to send training sequences in one period. Instead, the coordinator can group devices together and schedule each group to send training sequences in a specific order. For example, the location of static devices can be updated infrequently, compared to that of mobile devices. The time specified for each device may depend on the device's capability which is known to the coordinator after the association process.

Referring to FIG. 2, after the coordinator identifies and announces the order and identifier of nodes that will transmit training sequences in each training period, in block 10, the coordinator sends the training sequence in the CDP, as indicated in block 12. Thereafter, the new device C finds the coordinator and its direction, as indicated in block 14, and transmits its training sequence in the NDP, as indicated in block 16. After the NDP, each of the existing devices, such as the devices A and B and the coordinator, find the new device and its direction, as indicated in blocks 18, 20, and 22.

Then, the first device A sends its training sequence in the ODP, as indicated in block 24. At the same time, the new device finds the old device A and its direction, as indicated in block 28. Thereafter, the device B sends its training sequence in the ODP, as indicated in block 26, and at that time, the new device C finds the old device B and its direction, as indicated in block 30.

Then, the coordinator can allocate dedicated slots to associate with the new device using the obtained direction information in transmission and reception when communicating with the new device, as indicated in block 32. Thus, in the future, each device can use the direction information from the discovery periods to communicate with neighbors.

When a new device joins the network, the new device is guaranteed to be discovered by existing members in the network in some embodiments. In addition, the existing members are able to train their antennas and obtain the direction information to the new device. If an existing device changes its location, its new location information can be discovered dynamically by other devices.

The control 40, in the coordinator 36 for example, may also make a determination of whether or not two links can be activated simultaneously in what may be called spatial reuse. In spatial reuse, two links within close neighborhood can operate concurrently since their energy is focused in different directions and do not cause interference with each other. Thus, two devices within the network may communicate with each other at the same time two other devices are communicating. This is a direct result of the directionality provided by directional antennas. That is, the directionality of the antenna enables two devices to communicate without interfering with two other communication devices in the same network.

“Node direction compatibility” information is information that indicates whether two nodes can communicate in a given direction at the same time two other nodes are communicating in a different direction. In one embodiment, the coordinator stores the node direction compatibility information for all the nodes in the network. The coordinator begins compiling this information during the neighbor discovery process, and updates the information thereafter, for example, periodically, in one embodiment. Also, nodes can provide information to the coordinator about interference experiences.

To facilitate spatial reuse, each device that is transmitting may include its transmitting direction in a packet such as the PHY header or the MAC header. (Alternatively, the header may indicate that the packet is sent using true omnidirectional antennas, in which case there is no need to look at spatial reuse).

To the greatest possible extent, a node or device monitors all communications over all existing links announced by the coordinator 34 for the network. A receiving device 36 tries to use the pseudo-omni mode where the device spins its beam around in each direction when receiving. Alternatively, the coordinator 34 can also dedicate channel time for each device 36 to send probe/training packets so that neighboring devices can listen to gather topology information.

A device 36, after monitoring the existing links, then constructs a table summarizing the direction that it receives interference, called the “receive direction,” a node from which the interference comes denoted as a “neighbor,” and the direction from which the interfering node is transmitting, denoted the “transmit direction.”

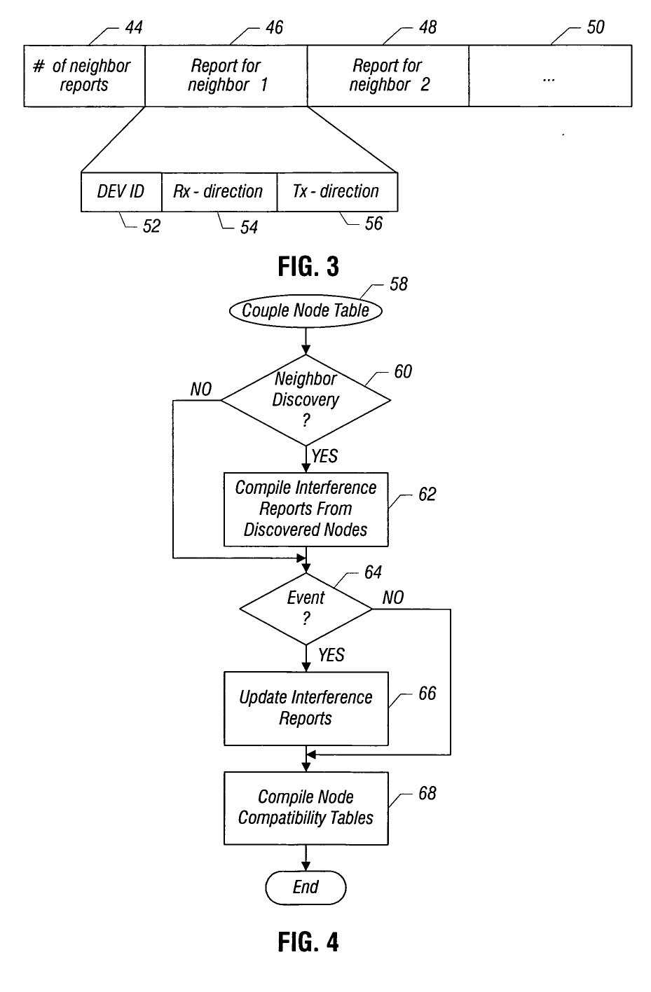

After constructing a node direction table, each node or device 36 then feeds back that information to the coordinator 34, as feasible, for example, during contention periods, dedicated management periods or dedicated traffic periods, or opportunistically as time is available. The information can be structured in the format shown in FIG. 3 in one embodiment. Each report for a particular neighbor corresponds to a row in the table of FIG. 3 that represents that neighbor. Thus, in FIG. 3, block 44 gives the number of neighbor reports, block 46 gives the report for interference with neighbor 1 which, when expanded, gives the device identifier 46, receive direction 54, and the transmit direction 56. Corresponding reports for other neighbors are contained in blocks 48 and 50.

The control 40 (FIG. 1) first builds an active node direction list for each traffic reservation period in the form [(Tx-node ID, Tx-direction), (Rx-node-ID, Rx-direction)]. When a node requests a channel reservation with another node, the coordinator 34 first evaluates whether there is available channel time left. If not, the coordinator 34 conducts a spatial reuse feasibility assessment based on the information gathered by the devices.

As an example, assume two nodes B and C are communicating and both have indicated to the control 40 the directions they are using. Suppose B uses direction 1 and C uses direction 4. The control 40 then records the node direction information for this traffic as [(B,1) (C,4)]. Furthermore, it is assumed that any changes in direction caused by mobility or other effects will be communicated to the control 40.

If, for example, nodes A and D are requesting that the coordinator 45 initiate a new connection, the coordinator 45 needs to evaluate whether it can grant this reservation.

In one embodiment, the coordinator 45 may establish compatibility table for the nodes in the network. It does this by compiling reports of interference from the various nodes. Thus, in one embodiment, the compiled node table sequence 58 may be implemented in software and stored in association with the storage 42 on the coordinator 34. In a software embodiment, code may be stored as a series of instructions that are recorded in a computer readable medium, such as the storage 42 in the coordinator 34. The storage 42 may be a semiconductor memory, a magnetic memory, or an optical memory, to mention a few examples. In any case, the storage 42 may be generally called a computer readable medium.

A check at diamond 60 determines whether or not a neighbor discovery sequence is in operation, for example, as depicted in FIG. 2. If so, interference reports may be compiled by the coordinator during the neighbor discovery period as indicated in block 62. Next, a check at 64 determines whether an event has occurred. An event could be a time out, which indicates that the node compatibility table should be updated, the occurrence of a given number of reports from nodes, or even the occurrence of a request for spatial reuse, to mention a few examples. If such an event occurs, the interference reports that have been received up to this time may be compiled into an appropriate table for use in determining whether spatial reuse between two particular nodes is appropriate. Then, the node compatibility tables may be compiled, as indicated in block 68.

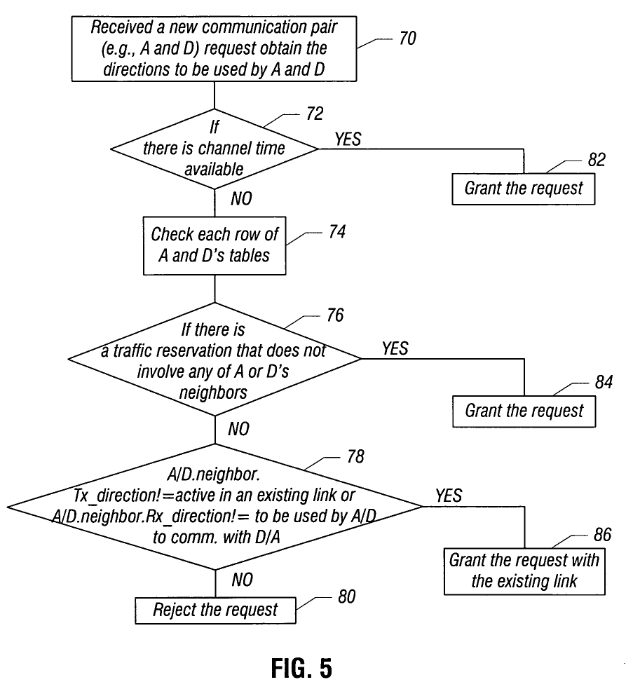

Referring to FIG. 5, after receiving a new communication pair request (block 70), the control 40 (in coordinator 36 in one embodiment) first evaluates whether there is still available channel time in the superframes, as indicated in block 72. If there is, then the request is granted, as indicated in block 82.

If there is no available channel time, then the control 40 evaluates whether this communication can spatially reuse the channel time with an existing link (block 74). In particular, if there is no existing traffic reservation used by nodes that are neither A or D's neighbors, as indicated at block 76, then the control knows that A and D will not cause interference, nor receive interference and, thus, it can grant the channel to A and D in parallel to the existing link, as indicated in block 84.

Otherwise, if there is no such traffic reservation available, then the control 40 evaluates whether A and D's neighbors have active communication, but will not interfere with A and D (diamond 78). More specifically, the control 40 evaluates whether A and D use different directions from the ones that they are overhearing neighbors on an existing traffic reservation, indicated as A/D.neighbor.Rx direction!=the direction to be used by A and/or D to communicate with D and/or A. In other words, even though these neighbors are active, to avoid interference, A and D might use other directions away from the directions used by these neighbors. The control also evaluates whether A and D's neighbors are using directions not recorded on A and D's tables, as indicated in block 78, as indicated by A/D.neighbor.Tx-direction!=active. In other words, even those these neighbors are active, they may use directions away from A and D and, thus, they will not interfere with A and D. This is indicated as the condition A/D.neighbor.Tx_direction!=active.

If one of those conditions is met, then the control 40 grants the request and allocates the channel time in parallel to the existing link, as indicated in block 86. If not, then spatial use cannot be enabled and the communication request is denied, as indicated in block 80.

As an example, when a control 40 receives a communication request from A and D, it knows that A is going to use direction 6 to communicate with D, as one example. However, from A's node direction table, node A will receive interference from C if C is using direction 4. The control 40 then looks at the directions used by nodes B and C. Since node C is indeed using direction 4 in an existing link, the communication between A and D will interfere with B and C unless the control cannot grant the request.

As still another example, a node direction table may be as follows:

| Neighbor | Rx direction | Tx direction |
|---|---|---|
| B | 3 | 1 |
| C | 6 | 4 |
| D | 4 | 2 |

Now the control 40 knows that A will use direction 4 to communicate with node D instead of direction 6, as in the previous example. It also knows that node D did not report interference/neighbors from this direction. Thus, the existing link from node B to C is not in the same direction as the communication between nodes A and D. Therefore, the control 40 grants this communication request in parallel to B and C's communication.

In some embodiments, a highly efficient topology-aware intra piconet special reuse mechanism may be used for nodes within a wireless personal area network. Such spatial reuse mechanism allows the control to evaluate the feasibility of any communication pair based on topology information without causing an interruption to an existing link.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
transmitting an antenna training sequence from a directional antenna in a plurality of different directions.

2. The method of claim 1 including assigning a period for devices within a network to monitor for the transmission of said training sequence.

3. The method of claim 2 including assigning a first time period for existing devices that are already part of the network to transmit training sequences.

4. The method of claim 3 including providing a second period, different from said first period, for new devices that wish to join the network to transmit training sequences.

5. The method of claim 4 including monitoring for interference during the transmission of training sequences.

6. The method of claim 4 including assigning a coordinator to receive interference reports from devices within a network.

7. The method of claim 6 including transmitting interference reports as a result of training sequences during the second discovery period.

8. The method of claim 1 including enabling the coordinator to compile information about interference between two different devices in particular locations and particular directions.

9. The method of claim 8 including enabling the coordinator to indicate whether spatial reuse can occur using said compiled information.

10. The method of claim 9 including updating said compiled information in response to the occurrence of an event.

11. The method of claim 10 including updating in response to the passage of time.

12. The method of claim 10 including updating opportunistically as time to update is available.

13. The method of claim 10 including updating in response to the occurrence of a given number of interference reports.

14. The method of claim 8 wherein enabling the coordinator to indicate whether to allow spatial reuse can occur, includes using a table that indicates for a first wireless device whether the first wireless device experienced interference from a second wireless device in a particular direction in the course of a communication in the past.

15. A wireless node comprising:
a directional antenna; and
a control to cause the antenna to transmit a training sequence in a plurality of different directions.

16. The node of claim 15, said control to assign a period for devices within a network to monitor for the transmission of said training sequence.

17. The node of claim 16, said control to assign a first time period for devices that are already part of the network to transmit their training sequences.

18. The node of claim 17, said control to provide a second period, different from said first period, for new devices that wish to join the network to transmit training sequences.

19. The node of claim 18, said control to receive interference reports from devices in the network.

20. The node of claim 19, said node to compile information about interference between different devices in particular locations and particular directions.

21. The node of claim 20, said control to determine whether spatial reuse can occur based on said compiled information.
